(19) United States
(12) Patent Application Publication
(10) Pub. No.: US 2014/0143245 A1
(43) Pub. Date: May 22, 2014

(54) SEARCH RESULTS DISPLAY METHOD, DEVICE, SYSTEM AND COMPUTER STORAGE MEDIUM

(71) Applicant: TENCENT TECHNOLOGY (SHENZHEN) COMPANY LIMITED, Shenzhen City (CN)

(72) Inventors: Jianxiu QIAO, Shenzhen City (CN); Xiang LI, Shenzhen City (CN)

(73) Assignee: TENCENT TECHNOLOGY (SHENZHEN) COMPANY LIMITED, Shenzhen City (CN)

(21) Appl. No.: 14/166,172

(22) Filed: Jan. 28, 2014

Related U.S. Application Data
(63) Continuation of application No. PCT/CN2013/071749, filed on Feb. 21, 2013.

(30) Foreign Application Priority Data
Mar. 7, 2012 (CN) 201210058343.4

(51) Int. Cl. G06F 17/30

(52) U.S. Cl. CPC G06F 17/30867; G06F 17/3053
USPC 707/728

(57) ABSTRACT

The application provides a search results display method, device, system and a computer storage medium, the method includes: acquiring ordering factors and corresponding ordering weight information in response to a first selection operation of the user; determining an order of the search results according to the ordering factors and corresponding ordering weight information; and displaying the search results after adjusting the order. The present application can flexibly fit the individualized search intention of the user.

### CROSS-REFERENCE TO RELATED APPLICATIONS

This application is a continuation of International Application No. PCT/CN2013/071749, filed on Feb. 21, 2013, which claims priority to Chinese patent application No. 201210058343.4, filed on Mar. 7, 2012, the contents of which are incorporated herein by reference in their entirety.

### FIELD OF THE INVENTION

The present application relates to the search technical field, particularly to a search results display method, device, system and a computer storage medium.

### BACKGROUND

From the viewpoint of different information demands, a user often has different requirements for the display order of search results. For example, when the user searches current news, he not only requires that the search results are ordered according to relevance to search conditions so that news contents that have a high degree of match to the search intention can be browsed preferably, but also has a requirement for timeliness of the content searched out, so as to first browse the news content having high timeliness.

However, existing search engines, when displaying search results based on the search conditions provided by the user, usually order the search results only according to relevance to search conditions, and are unable to meet diversified search demands from users.

### SUMMARY

An object of the embodiments of the present application is to provide a search results display method, aimed at addressing the problem that existing search engines can only order the display of search results according to relevance to search conditions.

An embodiment of the present application is implemented by a search results display method, including:

acquiring ordering factors and corresponding ordering weight information in response to a first selection operation of the user;

determining an order of the search results according to the ordering factors and corresponding ordering weight information; and

displaying the search results after adjusting the order,

the ordering factors include at least one of relevance between the search results and search conditions, timeliness of the search results and authority of a source site of the search results, and

the step of determining an order of the search results according to the ordering factors and corresponding ordering weight information includes:

configuring a computation formula related to the order of the search results according to the ordering factors and corresponding ordering weight information;

computing ordering scores of the search results through the computation formula; and

ordering the ordering scores according to a predetermined order to determine the order of the search results.

Another object of the embodiment of the present application is to provide a search results display method, including:

acquiring ordering factors and corresponding ordering weight information in response to a first selection operation of the user;

determining an order of the search results according to the ordering factors and corresponding ordering weight information; and

displaying the search results after adjusting the order.

Another object of the embodiment of the present application is to provide a search results display device, including:

an acquiring module is configured to acquire ordering factors and corresponding ordering weight information in response to a first selection operation of the user;

an ordering module is configured to determine an order of the search results according to the ordering factors and corresponding ordering weight information; and

a displaying module is configured to display the search results after adjusting the order.

Another object of the embodiment of the present application is to provide a computer storage medium, in which is stored a computer program used for executing the above mentioned method.

Another object of the embodiment of the present application is to provide a search results display system, the system comprises a search results display device, and the search results display device includes:

an acquiring module is configured to acquire ordering factors and corresponding ordering weight information in response to a first selection operation of the user;

an ordering module is configured to determine an order of the search results according to the ordering factors and corresponding ordering weight information; and

a displaying module is configured to display the search results after adjusting the order.

In the preferred embodiments of the present application, by setting the ordering factors and corresponding ordering weights by the user himself, the search results conforming to the user's search condition can be ordered and displayed according to the user's focus on each ordering factor, and the search results will be more accurate, fitting the individualized search intention of the user more flexibly.

### BRIEF DESCRIPTION OF THE DRAWINGS

FIG. 1 is a flow diagram of an implementation of a search results display method provided according to an embodiment of the present application.

FIG. 2 is a flow diagram of a specific implementation of determining an order of each search result in a search results display method of FIG. 1 according to an embodiment of the present application.

FIG. 3 is a flow diagram of an implementation of a search results display method provided according to an embodiment of the present application.

FIG. 4 is a structural block diagram of a search results display device provided according to an embodiment of the present application.

### DETAILED DESCRIPTION

In order to make the objects, technical solutions and advantages of the present application more apparent and understandable, the present application will be further described below in conjunction with drawings and embodiments. It should be understood that the specific embodiments described herein are only used to explain the present application and are not used for limiting the present application.

In the embodiments of the present application, by setting the ordering factors and corresponding ordering weights by the user himself, the search results conforming to the user's search condition can be ordered and displayed according to the user's focus on each ordering factor, fitting the individualized search intention of the user more flexibly.

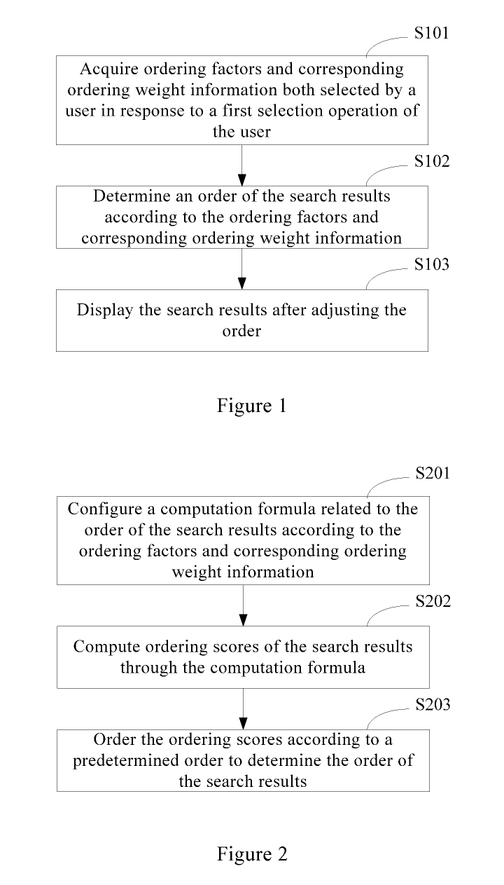

FIG. 1 is a flow diagram of an implementation of a search results display method provided according to an embodiment of the present application, which is detailed as follows:

In step S101, ordering factors and corresponding ordering weight information both selected by a user are detected, i.e., the ordering factors and corresponding ordering weight information both selected by a user are acquired in response to a first selection operation of the user.

The ordering factors include, but not limited to, at least one of relevance between the search results and search conditions, timeliness of the search results and authority of a source site of the search results, where, the relevance represents a matching degree between the search results and search conditions, the timeliness of the search results represents the freshness of the information content contained therein, and the authority of a source site is the evaluation for the a source site of the search results. Considering comprehensively from the scale, access amount and etc. of the site, those sites having a large site scale and a great access amount have a relatively high site authority.

In the present embodiment, the user can select an ordering factor conforming to the search intention of himself and endows a corresponding ordering weight information to the selected ordering factor. For example, the weights of the ordering factors are identified from low to high by using scores of 1 to 5. When the user is searching news contents, since the news has timeliness, what the user pays the most attention to is timeliness of search results, and timeliness is endowed ordering weight information of 5. Secondly it is the relevance between news contents and search conditions, and the relevance is endowed ordering weight information of 3. Meantime, the authority of a source site of the search results need also to be considered, since the web sites having a high site authority and the news content thereof correspondingly have a relatively high news value or a news Credibility, and the size authority is endowed ordering weight information of 1.

As an embodiment of the present application, the system can also predefine several sets of ordering factors and corresponding ordering weight information, for example, one to five levels of ordering modes are set which correspond to the cases that self-defined orders gradually transition from relevance priority to timeliness priority. When the user selects level 1, the order of the search results does not consider timeliness at all, i.e., the weight corresponding to timeliness is set to 0; level 3 is a default ordering mode of the system, considers comprehensively such ordering factors as timeliness, relevance and authority, and blends the factors to a certain degree to obtain an optimum ordering effect; level 2 is located between level 1 and level 3, and with respect to level 1, the weight of its timeliness ordering factor is somewhat increased but is still lower than the weight of its timeliness ordering factor in level 3, while the weight of its relevance ordering factor is somewhat decreased but is still higher than the weight of its relevance ordering factor in level 3; when the user selects level 5, the order of the search results does not consider relevance at all, i.e., the weight corresponding to relevance is set to 0; and likewise, level 4 is located between level 3 and level 5, both pieces of the ordering weight information of its timeliness and the relevance ordering factors locate between level 3 and level 5.

In the specific implementation process, the user can only select an ordering factor as required, or select a plurality of ordering factors simultaneously, so as to flexibly set the search requirement of himself.

In step S102, the order of each search result is determined according the ordering factors and corresponding ordering weight information.

In step S103, the search results after adjusting the order are displayed.

In the present embodiment, after determining the ordering factors and corresponding ordering weight information needed to consider, the order of each search result is determined according the ordering factors and corresponding ordering weight information both selected by the user, and finally the ordered search results are displayed to the user.

Specifically, FIG. 2 is a flow diagram of a specific implementation of determining an order of each search result in a search results display method of FIG. 1 according to an embodiment of the present application, which is the refinement of step S102 of the first embodiment of the present application, and its specific implementation process is described in detail as follows:

In step S201, a computation formula related to the order of the search results is configured according to the ordering factors and corresponding ordering weight information.

In the present embodiment, a corresponding computation formula is configured according to the determined ordering factors and corresponding ordering weight information. For example, the ordering factors determined by the user include relevance, timeliness and authority simultaneously, then the configuring operation considers the computation formulae of the three ordering factors simultaneously, and adjusts the related parameters in the computation formulae according the corresponding ordering weight information; and if the ordering factors determined by the user include only relevance, then the configured computation formula considers such an ordering factor of relevance.

It should be indicated that, in the embodiment of the present application, the computation formula for computing ordering scores can have different forms based on the difference of the algorithms, which will not be defined herein.

In step S202, the ordering scores of the search results are computed through the computation formula.

In the present embodiment, an ordering score for ordering is computed for each search result based on the configured computation formula. The ordering score is different according to each search result. For example, the search intention of the user tends to be time priority, then timeliness has a relatively great influence on the ordering scores of the search results, and the closer to the current time the release time is, the higher the ordering score of the search result is. If the search intention of the user tends to be relevance priority, then relevance has a relatively great influence on the ordering scores of the search results, and the higher the fitness between the content of the search result and the search condition is, the higher the ordering score of the search result is.

In step S203, the ordering scores are ordered according a predetermined order to determine the order of the search results, for example, the order of each search result is determined according to the ordering scores from high to low.

In the embodiments of the present application, by setting the ordering factors and corresponding ordering weights by the user himself, the search results conforming to the user's search condition can be ordered and displayed according to the ordering factors and corresponding ordering weight information set by the user, fitting the individualized search intention of the user more flexibly.

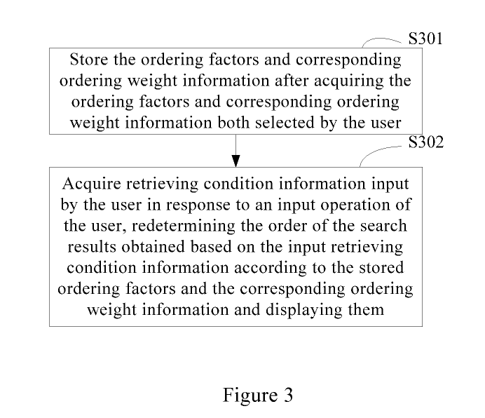

FIG. 3 shows an implementation flow of a search results display method provided according to an embodiment of the present application, which is detailed as follows.

In step S301, the ordering factors and corresponding ordering weight information are stored after acquiring the ordering factors and corresponding ordering weight information both selected by the user.

In step S302, retrieving condition information input by the user is acquired in response to an input operation of the user, the order of the search results obtained based on the input retrieving condition information is determined and displayed again according to the stored ordering factors and the corresponding ordering weight information.

In the present embodiment, the ordering factors and corresponding ordering weight information detected in step S101 is stored in a cache. When the user inputs a retrieving condition next time, if it is not detected that the user makes any modification to the ordering factors and corresponding ordering weight information, then the stored ordering factors and corresponding ordering weight information are called from the cache directly to order and display the search results, simplifying the display process of the search results and increasing search efficiency of the user.

As an embodiment of the present application, the step of displaying the search results after adjusting the order in the search results display method of FIG. 1 includes: displaying in different pages the search results after adjusting the order. i.e., when displaying search results, the search results are displayed in different pages.

In addition, the method of the present embodiment further includes the following steps of: updating the ordering factors and corresponding ordering weight information in response to a second selection operation of the user, determining again the order of the search results according to the updated ordering factors and the corresponding ordering weight information, and jumping to a first page to display the reordered search results. i.e., when detecting the user has changed the ordering factors and corresponding ordering weight information, step S102 is executed again, the order of each search result is redetermined based on the changed ordering factors and corresponding ordering weight information, at which time, if the user has browsed the search results of the second page or the subsequent pages, then the page automatically jumps to the first page of the pages of the search results, and the reordered search results are displayed from the beginning

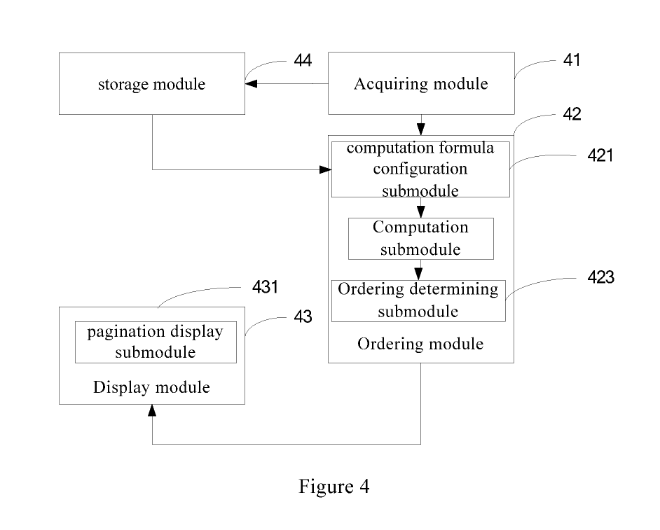

FIG. 4 shows the structure of a search results display device provided according to an embodiment of the present application and only shows the portion related to the present embodiment for convenience of explanation.

Referring to FIG. 4, the search results display device can be located in such search systems as a news search system, a web page search system and etc., which specifically includes an acquiring module 41, an ordering module 42 and a display module 43.

The acquiring module 41 is configured to detect the ordering factors and corresponding ordering weight information both selected by the user, i.e., the acquiring module 41 is configured to acquire ordering factors and corresponding ordering weight information both selected by a user in response to a first selection operation of the user.

The ordering module 42 determines an order of each search result according to the ordering factors and corresponding ordering weight information.

The display module 43 is configured to display the search results after adjusting the order.

Further, the ordering module 42 includes a computation formula configuration submodule 421, a computation submodule 422 and an ordering determining submodule 423.

The computation formula configuration submodule 421 is configured to configure a computation formula related to the order of the search results according to the ordering factors and corresponding ordering weight information.

The computation submodule 422 is configured to compute ordering scores of the search results through the computation formula.

The ordering determining submodule 423 is configured to order the ordering scores according to a predetermined order to determine the order of the search results. For example, the order of each search result is determined according the ordering scores from high to low.

As an embodiment of the present application, the search results display device further includes a storage module 44.

The storage module 44 is configured to store the ordering factors and corresponding ordering weight information after acquiring the ordering factors and corresponding ordering weight information both selected by the user. Therefore, when the user inputs the next retrieving condition, the ordering module 42 can be used for determining the order of each search result directly based on the ordering factors and corresponding ordering weight information stored in the storage module 44, i.e., the acquiring module is further used for acquiring retrieving condition information input by the user in response to an input operation of the user, and the ordering module is further used for determining again the order of the search results obtained based on the input retrieving condition information according to the stored ordering factors and the corresponding ordering weight information and displaying them.

As another embodiment of the present application, the display module 43 includes a pagination display submodule 431. The pagination display submodule 431 is configured to display ordered search results in different pages.

The acquiring module is further used for updating the ordering factors and corresponding ordering weight information in response to a second selection operation of the user. The ordering module is further used for determining again the order of the search results according to the updated ordering factors and the corresponding ordering weight information. The pagination display submodule is further used for jumping to a first page to display the reordered search results.

Specifically, when the search results are displayed in different pages, when it is detected that the user has changed the ordering factors and corresponding ordering weight information, the ordering module 42 redetermines the order of each search result based on the changed ordering factors and corresponding ordering weight information, and the pagination display submodule 431 automatically jumps to a first page to display the reordered search results.

An search results display system of the embodiments of the present application includes the above mentioned search results display device.

In the preferred embodiments of the present application, by setting the ordering factors and corresponding ordering weights by the user himself, the search results conforming to the user's search condition can be ordered and displayed according to the user's focus on each ordering factor, fitting the individualized search intention of the user more flexibly.

A computer storage medium according to one preferred embodiment of the present application stores therein a computer program, the computer program is used for executing the above mentioned search results display method, i.e., the computer program is a instruction program of a function for displaying search results, that can be executed by a computer, the function includes:

acquiring ordering factors and corresponding ordering weight information both selected by a user in response to a first selection operation of the user;

determining an order of the search results according to the ordering factors and corresponding ordering weight information; and

displaying the search results after adjusting the order.

As an improvement, the function may further include:

the ordering factors include at least one of relevance between the search results and search conditions, timeliness of the search results and authority of a source site of the search results.

As another improvement, the function may further include:

the step of determining an order of the search results according to the ordering factors and corresponding ordering weight information includes:

configuring a computation formula related to the order of the search results according to the ordering factors and corresponding ordering weight information;

computing ordering scores of the search results through the computation formula; and

ordering the ordering scores according to a predetermined order to determine the order of the search results.

As another improvement, the function may further include:

storing the ordering factors and corresponding ordering weight information after acquiring the ordering factors and corresponding ordering weight information both selected by the user.

As another improvement, the function may further include:

acquiring retrieving condition information input by the user in response to an input operation of the user, determining again the order of the search results obtained based on the input retrieving condition information according to the stored ordering factors and the corresponding ordering weight information and displaying them.

As another improvement, the step of displaying the search results after adjusting the order may include:

displaying in different pages the search results after adjusting the order.

As another improvement, the function may further include:

updating the ordering factors and corresponding ordering weight information in response to a second selection operation of the user, determining again the order of the search results according to the updated ordering factors and the corresponding ordering weight information and displaying them, and jumping to a first page to display the reordered search results.

What are described above are only preferred embodiments of the present application, and are not used for limiting the present application. Any modifications, equivalent substitutions and improvements made within the spirit and principle of the present application should be incorporated in the protection scope of the present application.

1. A search results display method, comprising:
acquiring ordering factors and corresponding ordering weight information in response to a first selection operation of the user;
determining an order of the search results according to the ordering factors and corresponding ordering weight information; and
displaying the search results after adjusting the order.

2. The method according to claim 1, wherein the ordering factors include at least one of: relevance between the search results and search conditions, timeliness of the search results, and authority of a source site of the search results.

3. The method according to claim 1, wherein the step of determining an order of search results according to the ordering factors and corresponding ordering weight information includes:
configuring a computation formula related to the order of the search results according to the ordering factors and corresponding ordering weight information;
computing ordering scores of the search results through the computation formula; and
ordering the ordering scores according to a predetermined order to determine the order of the search results.

4. The method according to claim 1, wherein the method further includes:
storing the ordering factors and corresponding ordering weight information after acquiring the ordering factors and corresponding ordering weight information both selected by the user.

5. The method according to claim 4, wherein the method further includes:
acquiring retrieving condition information input by the user in response to an input operation of the user, determining again the order of the search results obtained based on the input retrieving condition information according to the stored ordering factors and the corresponding ordering weight information and displaying them.

6. The method according to claim 1, wherein the step of displaying the search results after adjusting the order includes:
displaying in different pages the search results after adjusting the order.

7. The method according to claim 6, wherein the method further includes:
updating the ordering factors and corresponding ordering weight information in response to a second selection operation of the user, determining again the order of the search results according to the updated ordering factors and the corresponding ordering weight information, and jumping to a first page to display the reordered search results.

8. A search results display device, comprising:
an acquiring module configured to acquire ordering factors and corresponding ordering weight information in response to a first selection operation of the user;
an ordering module configured to determine an order of the search results according to the ordering factors and corresponding ordering weight information; and
a displaying module configured to display the search results after adjusting the order.

9. The device according to claim 8, wherein the ordering module includes:
a computation formula configuration submodule configured to configure a computation formula related to the order of the search results according to the ordering factors and corresponding ordering weight information;
a computation submodule configured to compute ordering scores of the search results through the computation formula; and
an ordering determining submodule configured to order the ordering scores according to the a predetermined order to determine the order of the search results.

10. The device according to claim 9, wherein the device further includes:
a storage module configured to store the ordering factors and corresponding ordering weight information after acquiring the ordering factors and corresponding ordering weight information both selected by the user.

11. The device according to claim 10, wherein
the acquiring module is further configured to acquire retrieving condition information input by the user in response to an input operation of the user, and
the ordering module is further configured to determine again the order of the search results obtained based on the input retrieving condition information according to the stored ordering factors and the corresponding ordering weight information and displaying them.

12. The device according to claim 8, wherein the display module includes:
a pagination display submodule configured to display in different pages the search results after adjusting the order.

13. The device according to claim 12, wherein
the acquiring module is further configured to update the ordering factors and corresponding ordering weight information in response to a second selection operation of the user;
the ordering module is further configured to determine again the order of the search results according to the updated ordering factors and the corresponding ordering weight information; and
the pagination display submodule is further configured to jump to a first page to display the reordered search results.

14. A search results display system, wherein the system comprises a search results display device, and the search results display device includes:
an acquiring module configured to acquire ordering factors and corresponding ordering weight information in response to a first selection operation of the user;
an ordering module configured to determine an order of the search results according to the ordering factors and corresponding ordering weight information; and
a displaying module configured to display the search results after adjusting the order.

15. The system according to claim 14, wherein the ordering module includes:
a computation formula configuration submodule configured to configure a computation formula related to the order of the search results according to the ordering factors and corresponding ordering weight information;
a computation submodule configured to compute ordering scores of the search results through the computation formula; and
an ordering determining submodule configured to order the ordering scores according to the a predetermined order to determine the order of the search results.

16. The system according to claim 15, wherein
the search results display device further includes: a storage module configured to store the ordering factors and corresponding ordering weight information after acquiring the ordering factors and corresponding ordering weight information both selected by the user.

17. The system according to claim 16, wherein
the acquiring module is further configured to acquire retrieving condition information input by the user in response to an input operation of the user, and
the ordering module is further configured to determine again the order of the search results obtained based on the input retrieving condition information according to the stored ordering factors and the corresponding ordering weight information and displaying them.

18. The system according to claim 14, wherein the display module includes:
a pagination display submodule configured to display in different pages the search results after adjusting the order.

19. The system according to claim 18, wherein
the acquiring module is further configured to update the ordering factors and corresponding ordering weight information in response to a second selection operation of the user;
the ordering module is further configured to determine again the order of the search results according to the updated ordering factors and the corresponding ordering weight information; and
the pagination display submodule is further configured to jump to a first page to display the reordered search results.
